(19) United States
(12) Patent Application Publication
(10) Pub. No.: US 2025/0094795 A1
(43) Pub. Date: Mar. 20, 2025

(54) Automated Technical Recovery Exercise Evaluation And Testing

(71) Applicant: Capital One Services, LLC, McLean, VA (US)

(72) Inventors: Matthew Louis Nowak, Midlothian, VA (US); Laurie C. Brooks, Oilville, VA (US); Catherine Barnes, Glen Allen, VA (US); Lindsay Helbing, Manakin, VA (US); Elizabeth W. Phillips, North Chesterfield, VA (US)

(21) Appl. No.: 18/368,611

(22) Filed: Sep. 15, 2023

(51) Int. Cl. G06N 3/08

(52) U.S. Cl. CPC G06N 3/08

(57) ABSTRACT

Systems, methods, and apparatuses for automatically performing and evaluating technical recovery exercises are described. A trained machine learning model may be generated using training data. Technical recovery exercise data that indicates different technical recovery exercises, for each of a plurality of application failover waves, may be received. Applications associated with a first application failover wave may be executed. By monitoring events associated with the applications associated with the first application failover wave during first technical recovery exercises of the first application failover wave, event data may be generated. Event data may be provided as input to the trained machine learning model. Output data associated with application downtime and based on the event data, may be received as output from the trained machine learning model. Based on determining that the output data satisfies criteria, second applications associated with a second application failover wave may be executed.

### FIELD OF USE

Aspects of this disclosure relate to computer implemented systems and methods for performing and evaluating technical recovery exercises. More specifically, aspects of the disclosure provide for automatically monitoring the execution of application failover waves and performing subsequent application failover waves based on analysis of monitored events associated with the application failover waves.

### BACKGROUND

The performance of technical recovery exercises can be a time consuming process that involves a significant amount of manual supervision, review, and multiple rounds of various exercises. Further, performing technical recovery exercises may require a large amount of training data, some of which may not significantly contribute to improving the determination of which events are responsible for application downtime. Performance of technical recovery exercises may consume a great deal of computational resources that might otherwise be used on execution of applications for customers that use the services implemented by the applications. As a result, the process of determining applications that are associated with downtime may be difficult.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may address these and other problems, and generally improve the effectiveness with which technical recovery exercises may be performed and evaluated.

Aspects described herein may allow for automatic methods, systems, and apparatuses to generate and/or use a trained machine learning model that is configured to determine whether output associated with an application failover wave meets certain criteria associated with application downtime. The use of the disclosed technology may have the effect of conserving computing resources by reducing the wastage of computing resources that results from inefficient technical recovery exercises. Furthermore, by proactively analyzing event data associated with application failover waves and determining whether to process subsequent application failover waves, the disclosed technology may allow for more rapid performance of technical recovery exercises without sacrificing the effectiveness of the technical recovery exercises.

More particularly, some aspects described herein may provide a computer-implemented method that may comprise generating a trained machine learning model by training, using training data indicating historical technical recovery exercises and downtimes associated with the historical technical recovery exercises, a machine learning model implemented using an artificial neural network. Training the machine learning model may comprise weighting one or more nodes of the artificial neural network based on the training data. The computer-implemented method may comprise receiving, by a computing device, technical recovery exercise data that indicates, for each of a plurality of application failover waves, one or more different technical recovery exercises. The computer-implemented method may comprise, for a first application failover wave of the plurality of application failover waves: executing, by the computing device, one or more applications associated with the first application failover wave; generating, by the computing device and by monitoring one or more events associated with the one or more applications associated with the first application failover wave during one or more first technical recovery exercises of the first application failover wave, event data; providing, as input to the trained machine learning model, the event data; and receiving, as output from the trained machine learning model, output data, based on the event data, associated with application downtime. Furthermore, the computer-implemented method may comprise, based on determining that the output data satisfies one or more criteria, executing one or more second applications associated with a second application failover wave of the plurality of application failover waves.

According to some aspects described herein, the output data may comprise a system health score. The system health score may be positively correlated with the one or more applications associated with the first application failover wave operating within one or more target key performance indicator (KPI) ranges. Determining that the output data satisfies the one or more criteria may comprise determining that the system health score exceeds a threshold system health score.

According to some aspects described herein, the one or more criteria may comprise a threshold rate of logins to the one or more applications associated with the first application failover wave. Determining that the output data satisfies the one or more criteria may comprise determining that a rate of logins to the one or more applications is less than the threshold rate of logins.

According to some aspects described herein, the computer-implemented method may further comprise determining, based on the output data, an order of performing the plurality of application failover waves that is associated with satisfying the one or more criteria.

According to some aspects described herein, the computer-implemented method may further comprise receiving user feedback indicating an efficacy associated with the determining that the output data satisfies the one or more criteria. Further, the computer-implemented method may comprise further training, based on the user feedback, the trained machine learning model.

According to some aspects described herein, the one or more second applications associated with the second application failover wave may be different from the one or more applications associated with the first application failover wave.

According to some aspects described herein, the one or more different technical recovery exercises may comprise one or more of: a chaos experiment, regional isolation of the one or more applications, and/or automated traffic switching of the one or more applications.

According to some aspects described herein, the one or more criteria may comprise a recovery point objective (RPO). Further, determining that the output data satisfies the one or more criteria may comprise determining that an amount of data lost by the one or more applications associated with the first application failover wave does not exceed a threshold amount of data based on the RPO.

According to some aspects described herein, the one or more criteria may comprise a recovery time objective (RTO). Further, determining that the output data satisfies the one or more criteria may comprise determining that an amount of time used to perform a failover of the one or more applications associated with the first application failover wave does not exceed a threshold amount of time based on the RTO.

According to some aspects described herein, the output data may comprise a risk associated with executing the one or more second applications associated with the second application failover wave. Further, determining that the output data satisfies the one or more criteria may comprise determining that the risk does not exceed a threshold risk. The risk may be positively correlated with a probability that the one or more second applications lose data or do not complete a failover.

According to some aspects described herein, the output data may comprise a number of the one or more second applications associated with the second application failover wave.

According to some aspects described herein, the output data may comprise one or more indications of one or more types of the one or more second applications associated with the second application failover wave.

Some aspects described herein may provide a computing device, comprising: one or more processors; and memory storing instructions that, when executed by the one or more processors, cause the computing device to perform steps. The steps may comprise generating a trained machine learning model by training, using training data indicating historical technical recovery exercises, key performance indicator (KPI) ranges, and downtimes associated with the historical technical recovery exercises, a machine learning model implemented using an artificial neural network. The training the machine learning model may comprise weighting one or more nodes of the artificial neural network based on the training data. The steps may comprise receiving technical recovery exercise data that indicates, for each of a plurality of application failover waves, one or more different technical recovery exercises. The steps may comprise for a first application failover wave of the plurality of application failover waves: executing one or more applications associated with the first application failover wave; generating, by monitoring one or more events associated with the one or more applications associated with the first application failover wave during one or more first technical recovery exercises of the first application failover wave, event data; providing, as input to the trained machine learning model, the event data; and receiving, as output from the trained machine learning model, output data, based on the event data, associated with application downtime. Furthermore, the steps may comprise, based on determining that the output data satisfies one or more criteria, executing one or more second applications associated with a second application failover wave of the plurality of application failover waves.

Some aspects described herein may provide a non-transitory machine-readable medium storing instructions that, when executed by one or more processors, cause the one or more processors to perform steps. The steps may comprise generating a trained machine learning model by training, using training data indicating historical technical recovery exercises and downtimes associated with the historical technical recovery exercises, a machine learning model implemented using an artificial neural network. Training the machine learning model may comprise weighting one or more nodes of the artificial neural network based on the training data. The steps may comprise receiving technical recovery exercise data that indicates, for each of a plurality of application failover waves, one or more different technical recovery exercises. The steps may comprise, for a first application failover wave of the plurality of application failover waves: executing one or more applications associated with the first application failover wave; generating, by monitoring one or more events associated with the one or more applications associated with the first application failover wave during one or more first technical recovery exercises of the first application failover wave, event data; providing, as input to the trained machine learning model, the event data; and receiving, as output from the trained machine learning model, output data, based on the event data, associated with application downtime. The output data may comprise a system health score that is positively correlated with the one or more applications operating within one or more target key performance indicator (KPI) ranges. Furthermore, the steps may comprise, based on determining that the output data satisfies one or more criteria, executing one or more second applications associated with a second application failover wave of the plurality of application failover waves, wherein the determining that the output data satisfies the one or more criteria may comprise determining that the system health score exceeding a threshold system health score.

Corresponding apparatuses, devices, systems, and computer-readable media (e.g., non-transitory computer readable media) are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates an example of a computing system that may be used to implement one or more aspects of the disclosure in accordance with one or more illustrative aspects discussed herein;

FIG. 2. illustrates an example deep neural network architecture for a model according to one or more aspects of the disclosure;

FIG. 3 illustrates an example flow chart for a method of performing and evaluating technical recovery exercises according to aspects of the disclosure;

FIG. 4 illustrates an example flow chart for a method of training a machine learning model according to aspects of the disclosure;

FIG. 5 illustrates an example flow chart for a method of training a machine learning model to determine whether output data satisfies one or more criteria according to aspects of the disclosure;

FIG. 6 illustrates a data flow associated with performance of technical recovery exercises according to aspects of the disclosure; and

FIG. 7 illustrates an example of a system for performing and evaluating technical recovery exercises according to aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

The process of performing and evaluating technical recovery exercises may be arduous and require a great deal of manual review and input. In some cases, after a technical recovery exercise is performed, the results of the technical recovery exercise are manually reviewed and may be evaluated based on a set of criteria which may include the use of recovery point objectives (RPOs) and/or recovery time objectives (RTOs). Further, in some cases a technical recovery exercise may use an inordinate amount of resources because the conditions for stopping the exercise are inflexible. In particular, time sensitive technical recovery exercises in which an issue with a configuration item needs to be addressed without undue delay are especially vulnerable to inefficiencies in the evaluation process. To improve the efficiency of technical recovery exercises, the aspects discussed herein may, for example, train machine-learning models to evaluate event data and generate and/or use output associated with application downtime. The machine-learning models may be configured and/or trained to more accurately evaluate technical recovery exercises that would result in excessive costs if not properly managed. Based on output from the machine-learning models, actions associated with the high risk technical recovery exercises may be performed to mitigate the risks and/or costs associated with the technical recovery exercises.

By way of introduction, aspects discussed herein may relate to systems, methods, and techniques for performing and/or evaluating technical recovery exercises. Further, the system may generate and/or use a trained machine-learning model using training data indicating historical technical recovery exercises and downtimes associated with the historical technical recovery exercises. For example, the historical technical recovery exercises may be based on previously performed technical recovery exercises that are associated with historical event data that indicates the performance of applications that were executed as part of the exercises. The machine learning model may be implemented using an artificial neural network and/or other types of configurations. Training the machine learning model may comprise weighting one or more nodes of the artificial neural network based on the training data. Technical recovery exercise data that indicate, for each of a plurality of application failover waves, one or more different technical recovery exercises may be received. For example, the technical recovery exercise data may indicate that a chaos experiment will be performed on banking applications that are executed in a particular geographic region.

Further, for a first application failover wave of the plurality of application failover one or more applications associated with the first application failover wave may be executed. For example, mobile banking applications may be executed in an isolated region and the technical recovery exercise may comprise automated attempts to log into the banking applications. Event data may be generated by monitoring one or more events associated with the one or more applications associated with the first application failover wave during one or more first technical recovery exercises of the first application failover wave. For example, the event data may indicate a number of logins being processed by an application and/or what portion of applications are still running. Further, the event data may be provided as input to the trained machine learning model which may generate and/or use output data that may be associated with application downtime based on the input. For example, the output data may indicate the portion of applications that have successfully processed logins over a predetermined time period (e.g., the past hour). Furthermore, based on determining that the output data satisfies one or more criteria, one or more second applications associated with a subsequent application failover wave (e.g., a second application failover wave) of the plurality of application failover waves may be executed. For example, based on a threshold number of applications successfully completing a failover, another wave of applications may be executed. The other wave of applications may comprise different applications from the first wave or may comprise a different composition of applications (e.g., some previously executed applications and some new applications that have not yet been executed). The techniques described here may serve to enhance the security and integrity of applications by improving the machine learning models that are used to determine whether application failover has been completed successfully. As such, using the disclosed technology to analyze the performance of applications in application failover waves allows potential weaknesses to be identified. The identification of these potential weaknesses may allow them to be addressed and may result in a more effective allocation of testing resources.

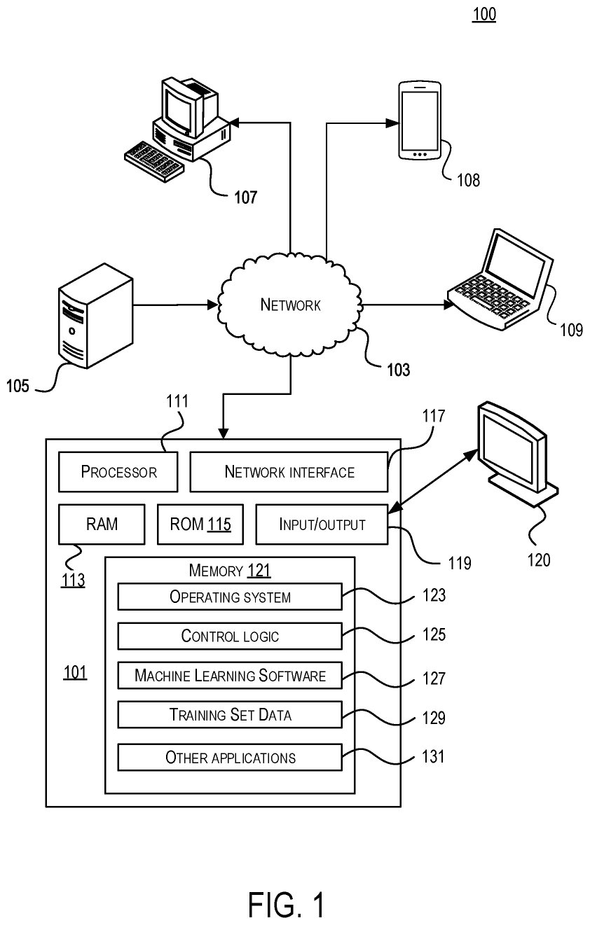

Before discussing these concepts in greater detail, however, several examples of a computing device that may be used in implementing and/or otherwise providing various aspects of the disclosure will first be discussed with respect to FIG. 1. FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smartphone, any other types of mobile computing devices, and the like), and/or any other type of data processing device.

Computing device 101 may, in some embodiments, operate in a standalone environment. In other embodiments, computing device 101 may operate in a networked environment. As shown in FIG. 1, various network nodes 101, 105, 107, 108, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 108, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces (I/O) 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning model 127 (e.g., software comprising instructions to implement a machine learning model), training data 129, and other applications 131. Training data 129 may comprise historical technical recovery exercises performed on a plurality of historical application failover waves comprising one or more applications. For example, training data 129 may comprise event data associated with the execution of one or more applications of a historical application failover wave. The event data may comprise various KPIs, incident data, RPOs, RTOs, and other data that indicates the state of the applications associated with the historical technical recovery exercises. Control logic 125 may be incorporated in and may be a part of machine learning model 127. In other embodiments, computing device 101 may include two or more of any and/or all of these components (e.g., two or more processors, two or more memories, etc.) and/or other components and/or subsystems not illustrated here.

Devices 105, 107, 108, 109 may have similar or different architecture as described with respect to computing device 101. Those of skill in the art will appreciate that the functionality of computing device 101 (or device 105, 107, 108, 109) as described herein may be spread across multiple data processing devices, for example, to distribute processing load across multiple computers, to segregate transactions based on geographic location, user access level, quality of service (QoS), etc. For example, devices 101, 105, 107, 108, 109, and others may operate in concert to provide parallel computing features in support of the operation of control logic 125 and/or machine learning model 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product. Having discussed several examples of computing devices which may be used to implement some aspects as discussed further below, discussion will now turn to systems, apparatuses, and methods for performing and evaluating technical recovery exercises.

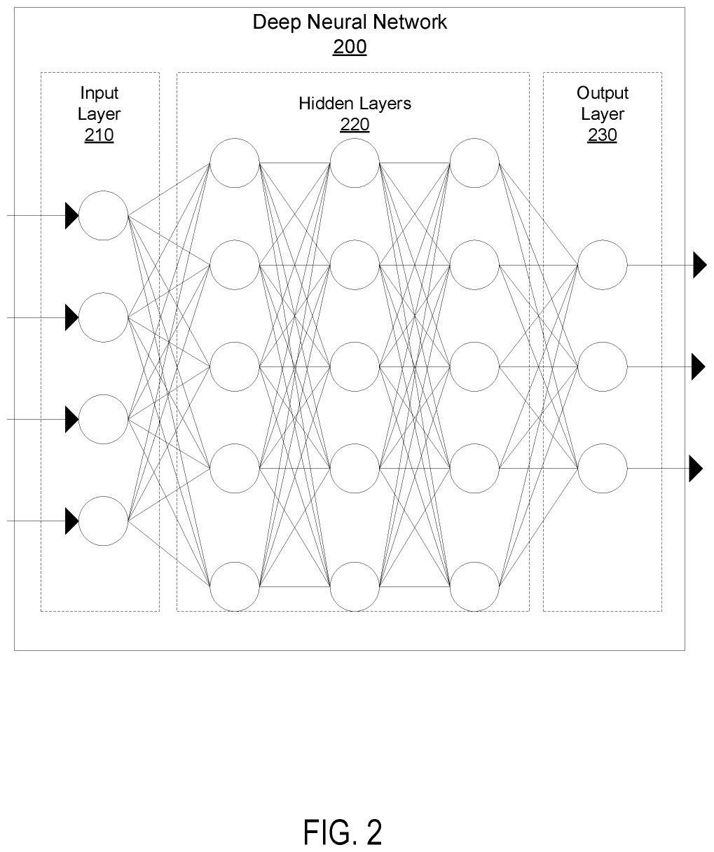

FIG. 2 illustrates an exemplary deep neural network architecture 200. Such a deep neural network architecture may comprise all or some portions of the machine learning model 127 described with respect to FIG. 1. That said, the architecture depicted in FIG. 2 need not be performed on a single computing device, and may be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. As illustrated, the neural network architecture 200 is depicted with three hidden layers, and thus may be considered a deep neural network. The number of hidden layers employed in the neural network architecture 200 (e.g., a deep neural network) may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

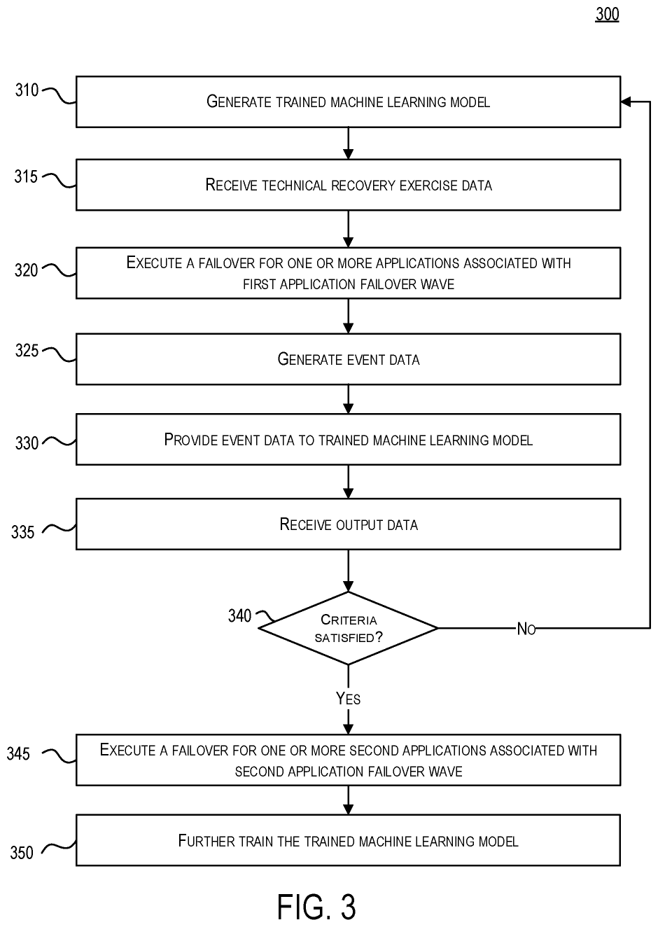

FIG. 3 illustrates an example flow chart for a method of performing and evaluating technical recovery exercises according to aspects of the disclosure. The steps of the method 300 are described with respect to FIG. 3 and may be implemented by a suitable computing system, as described further herein. For example, steps of the method described with respect to FIG. 3 may be implemented by any suitable computing environment by a computing device and/or combination of computing devices, such as computing devices 101, 105, 107, and 109 of FIG. 1. Further, steps of the method described with respect to FIG. 3 may be implemented in suitable program instructions, such as in machine learning model 127, and may operate on a suitable training set, such as training data 129.

In step 310, a computing system may generate and/or use a trained machine learning model. The trained machine learning model may be generated and/or used by training, using training data indicating historical technical recovery exercises and downtimes associated with the historical technical recovery exercises, a machine learning model. The machine learning model may be similar to the machine learning model 127 described with respect to FIG. 1. Further, the training data may be similar to the training data 129 described with respect to FIG. 1, and may be based on historical technical recovery exercises performed on a plurality of historical application failover waves comprising one or more applications.

The machine learning model may be implemented using an artificial neural network. Further, training the machine learning model may comprise weighting one or more nodes of the artificial neural network based on the training data. The machine learning model may include a recurrent neural network model (RNN), a convolutional neural network model (CNN), a support-vector network, a support vector machine (SVM), and/or a generative adversarial network (GAN).

For example, the computing system may input training data into the machine learning model. The training data may comprise historical technical recovery exercises of a plurality of application failover waves. For example, the training data may comprise at least one of an amount of time before application failure, one or more dates (e.g., days of the month) on which certain applications were offline, and/or one or more average down times for applications. Further, the historical technical recovery exercises may be associated with ground truth labels indicating whether each of the historical technical recovery exercises meets the one or more criteria. As a result, when a predicted probability of an application failover wave satisfying the one or more criteria is generated, the ground truth labels may be used to determine the accuracy of the machine learning model with respect to the predicted probabilities that were generated.

Generating and/or using the trained machine learning model may be based on the training data associated with one or more criteria (e.g., one or more criteria based on various performance metrics) of the historical technical recovery exercises of a plurality of application failover waves. The machine learning model may comprise parameters (e.g., adjustable weights and fixed biases) and each of the weights of the machine learning model may be adjusted based on the extent to which each of the weights contributes to increasing or decreasing the accuracy of output generated by the machine learning model. Based on a use of a loss function, the parameters may be adjusted so that a loss value of the loss function is minimized (e.g., the output of the machine learning model more closely corresponds to ground truth output that represents optimal output). For example, a weighting of the parameters that contribute to increasing the accuracy of the output of the machine learning model may be increased and a weighting of the parameters that contribute to decreasing the accuracy of the machine learning model may be decreased.

For example, the machine learning model may receive input comprising historical technical recovery exercises that include information about average down times for applications. The ground truth labels may comprise an indication of which applications did not successfully complete a failover when the average down time for the application exceeded a down time threshold. The output of the machine learning model may include a predicted probability that an application will successfully complete a failover. After generating the output, the predicted probability may be compared to ground truth labels to determine how accurately the machine learning model predicted the applications that would failover successfully. Parameters of the machine learning model may then be adjusted based on the extent to which the output of the machine learning model was similar to the ground truth labels.

By way of further example, as part of generating and/or using the trained machine learning model the computing system may generate, based on the training data, training output comprising predicted application downtimes associated with each of the historical technical recovery exercises. Further, the computing system may adjust a weighting of parameters of the machine learning model based on an accuracy of the predicted downtimes. For example, the weighting of parameters that are determined to make a greater contribution to accurately predicting application downtimes may be increased. Further, the weighting of parameters that are determined to make a lesser contribution (or no contribution) to accurately predicting application downtimes may be decreased. The machine learning model may be iteratively trained until the accuracy of the predicted downtimes achieves a sufficiently high level of performance (e.g., an accuracy of 95%).

As part of generating and/or using the trained machine learning model the computing system may generate, based on the training data, training output comprising predicted probabilities indicating whether each of the historical technical recovery exercises resulted in completion of a successful failover. Further, the computing system may adjust a weighting of parameters of the machine learning model based on an accuracy of the predicted probabilities. For example, the weighting of parameters that are determined to make a greater contribution to accurately predicting whether one or more historical applications of one or more historical application failover waves successfully failed over may be increased. Further, the weighting of parameters that are determined to make a lesser contribution (or no contribution) to accurately predicting whether one or more historical applications of one or more historical application failover waves completed a successful failover may be decreased. The machine learning model may be iteratively trained until the accuracy of the predicted probabilities achieves a sufficiently high level of performance.

In step 315, a computing system may receive technical recovery exercise data. The technical recovery data may indicate, for each of a plurality of application failover waves, one or more different technical recovery exercises. The one or more different technical recovery exercises may comprise instructions that may be implemented by one or more applications and/or one or more devices of the plurality of application failover waves. For example, the one or more technical recovery exercises may comprise instructions to disable and/or modify the operation of one or more applications (e.g., prevent logins from being authenticated by a certain portion of applications) and/or one or more devices. The one or more different technical recovery exercises may comprise a chaos experiment, regional isolation of the one or more applications, and/or automated traffic switching of the one or more applications. For example, the technical recovery exercise data may comprise one or more indications of computing devices (e.g., key server computing devices that manage logins to applications) that will be shut down or partially disabled for the duration of the technical recovery exercise. By way of further example, the technical recovery exercise data may comprise adding latency to communications by applications in order to disrupt the operation of the applications.

The technical recovery exercise data may be stored and/or distributed on a distributed network, similar to network 103, and on computing devices similar to computing devices 101 and/or 105. Further, the technical recovery exercise data may be accessed by a computing device, which may include the computing devices 101, 105, 107, 108, 109, any of which may access the technical recovery exercise data over a network (e.g., a network similar to network 103).

In step 320, a computing system may, for a first application failover wave of the plurality of application failover waves execute one or more applications associated with the first application failover wave (e.g., execute a failover for one or more applications associated with a first application failover wave). For example, the computing system may execute one or more banking applications. The one or more banking applications may be accessed via a web portal that is used to input a user name and passcode that are authenticated as part of logging into the banking application.

In step 325, a computing system may, for a first application failover wave of the plurality of application failover waves generate event data. The event data may be generated by monitoring one or more events associated with the one or more applications associated with the first application failover wave during one or more first technical recovery exercises of the first application failover wave. For example, the computing system may be configured to monitor the one or more applications to determine which of the one or more applications are operational, the performance of each of the one or more operations (e.g., a rate of logins for an application), and/or uptime for each of the one or more applications. The event data may comprise one or more indications of the one or more applications that failed during the first application failover wave, one or more indications of a duration that each of the one or more applications were not operational during the first application failover wave (e.g., downtime), one or more times at which one or more amounts of data are lost by each of the one or more applications, and/or an amount of time to perform a failover of the one or more applications that failed. In some embodiments, the event data may be generated based on use of one or more packet sniffers that monitor data packets associated with the one or more applications.

In step 330, a computing system may, for a first application failover wave of the plurality of application failover waves provide, as input to the trained machine learning model, the event data. For example, the event data provided as input to the trained machine learning model may comprise indications of which of the one or more applications are operational, which of the one or more applications are not operational, which of the applications malfunctioned, a rate of logins, an uptime for each of the one or more applications, an amount of time before one or more applications became nonoperational, an amount of time to perform a failover, and/or an amount of data communicated and/or lost by each of the one or more applications. The event data may have various forms and may for example comprise alphanumeric data (e.g., alphanumeric data to identify an RTO and corresponding numeric values and/or Boolean data (e.g., Boolean content to indicate whether a failover was successfully completed). Further, the trained machine learning model may be configured to receive event data as an input and the event data may be provided to the trained machine learning model by a computing system that generated and/or stored the event data. The trained machine learning model may be configured to output and/or generate output data. The output data may be based on the event data. For example, the trained machine learning model may receive input comprising the event data. The trained machine learning model may process, analyze, and/or perform operations on the event data and generate output comprising the output data.

In step 335, a computing system may receive output data. The output data may be received, for a first application failover wave of the plurality of application failover waves received, as output from the trained machine learning model. The output data may be based on the event data. Further, the output data may be associated with application downtime. The output data may comprise a risk associated with executing the one or more second applications associated with the second application failover wave. For example, the risk may be associated with a probability that attempting to execute the one or more applications associated with the second application failover wave may fail and/or result in data loss by the one or more applications of the first application failover wave and/or the second application failover wave. By way of further example, the output data may comprise an amount of downtime for each of the one or more applications, an amount of data lost by each of the one or more applications, and/or a time at which each of the one or more applications stopped operating.

The output data may comprise a number of the one or more second applications associated with the second application failover wave. For example, the trained machine learning model may be configured and/or trained to determine a number of the one or more second applications that may be associated with a second application failover wave. The number of the one or more second applications may be based on one or more numbers of one or more historical second applications that were used in historical technical recovery exercises.

The output data may comprise one or more indications of one or more types of the one or more second applications associated with the second application failover wave. For example, the trained machine learning model may be configured and/or trained to determine a type of the one or more second applications that may be associated with a second application failover wave. The type of the one or more second applications that may be may be associated with a second application failover wave based on one or more dependencies between the one or more second applications (e.g., one application being dependent on another application) and/or one or more dependencies on another application and/or resource by multiple applications (e.g., a first application and a second application both have dependencies on a third application). In some embodiments, the type of the one or more second applications may be based on one or more types of one or more historical second applications that were used in historical technical recovery exercises.

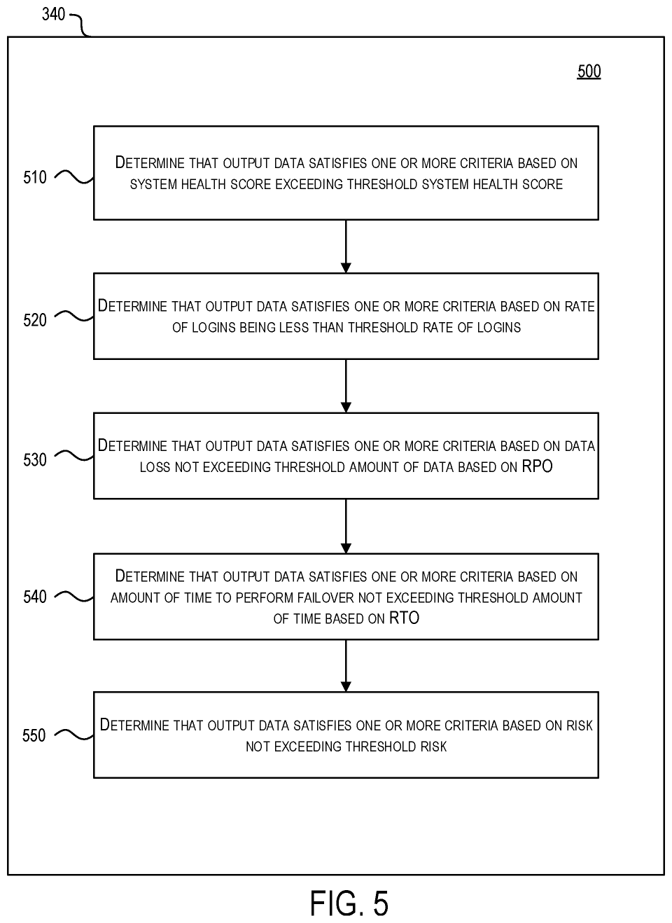

In step 340, a computing system may determine whether the output data satisfies one or more criteria. Determining whether the output data satisfies the one or more criteria may comprise comparing the output data to the one or more criteria. The one or more criteria may comprise a recovery point objective (RPO) which may be associated with a threshold amount of data that may be lost by the one or more applications of the first application failover wave. The one or more criteria may comprise a recovery time objective (RTO) which may be associated with an amount of time that may be used to perform a failover of the one or more applications associated with the first application failover wave. The one or more criteria may comprise a threshold rate of logins to the one or more applications associated with the first application failover wave. Steps, sub-steps, and/or operations associated with step 340 and/or the determination of whether the output data satisfies one or more criteria are described in steps 510-550 of the method 500 which is described with respect to FIG. 5.

Based on determining that the output data satisfies the one or more criteria, step 345 may be performed. For example, the output data may comprise information associated with an amount of data that was lost by the one or more applications of the first application failover wave. The computing system may compare the amount of data that was lost to an RPO threshold. Based on the amount of data that was lost being less than the RPO threshold, the computing system may determine that the one or more criteria are satisfied. Further, the output data may comprise information associated with an amount of data that was lost by the one or more applications of the first application failover wave. The computing system may compare an amount of time to perform a failover to an RTO threshold. Based on the amount of time to perform a failover being less than the RTO threshold, the computing system may determine that the one or more criteria are satisfied. By way of further example, the output data may comprise information associated with a rate of logins to the one or more applications associated with the first application failover wave. The computing system may compare the rate of logins to a threshold rate of logins. Based on the rate of logins being greater than or equal to the threshold rate of logins, the computing system may determine that the one or more criteria are satisfied.

Based on determining that the output data does not satisfy the one or more criteria, step 310 may be performed or the method may end. For example, the output data may comprise information associated with an amount of data that was lost by the one or more applications associated with the first application failover wave. The computing system may compare the amount of data lost to a threshold amount of data. Based on the amount of data lost being greater than or equal to the threshold amount of data, the computing system may determine that the one or more criteria are not satisfied.

The machine learning model may be configured to determine whether the output satisfies one or more key performance indicators. For example, the machine learning model may receive an input comprising the output data. The machine learning model may then perform operations on the input. The operations may comprise determining features of the output data that may be used to determine a probability that an application being executed successfully completed a failover. The machine learning model may then generate and/or use an output comprising a probability that the application failover wave was successfully completed.

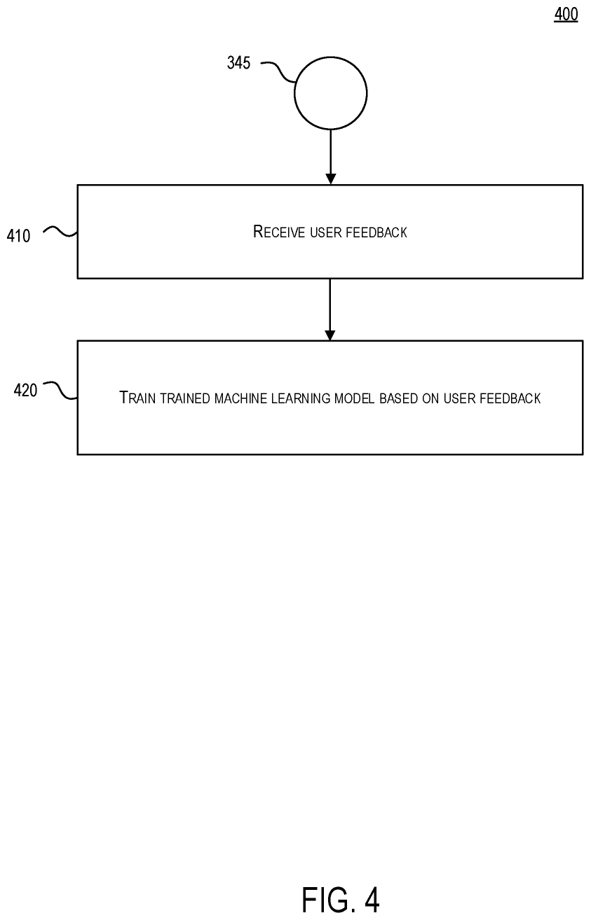

In step 345, a computing system may, based on determining that the output data satisfies one or more criteria, execute one or more second applications associated with a second application failover wave of the plurality of application failover waves (e.g., execute a failover for one or more second applications associated with a second application failover wave). The one or more second applications associated with the second application failover wave may be different from the one or more applications associated with the first application failover wave. For example, the computing system may execute one or more banking applications that are different from one or more banking applications associated with the first application failover wave. By way of further example, the one or more second applications associated with the second application failover wave may be different types of applications and/or applications that are located in a different geographic region. In some embodiments, steps 410 and/or 420 which are described with respect to FIG. 4, may be performed after step 345.

In step 350, a computing system may further train the trained machine learning model based on input comprising the output data and/or event data from one or more previous application failover waves. The trained machine learning model may be trained to more effectively predict application downtime and/or whether a subsequent application failover wave may be safel y completed. For example, the trained machine learning model may be further trained to determine a system health score (e.g., the system health score described with respect to step 510) that may be used to predict whether applications in an application failover wave have successfully completed a failover.

In some embodiments, further training the trained machine learning model may comprise determining, based on the output data, an order of performing the plurality of application failover waves that is associated with satisfying the one or more criteria. The computing system may analyze the output data and/or the event data to determine an order executing the plurality of application failover waves that results in more effective satisfaction of the one or more criteria. For example, the computing system may use the output data and/or the event data to determine an order of the plurality of application failover waves that reduces the time used to perform the technical recovery exercises, reduces application downtime, and reduces the time that applications use to successfully complete a failover.

The one or more applications may comprise various applications that may be associated with varying amounts of potential data loss and/or expenditure of time to perform a failover. For example, the one or more applications may comprise one or more low level applications and one or more high level applications. Failure and/or malfunction of the one or more low level applications may result in less significant adverse effects (e.g., less data loss and/or impact on failover time) than failure or malfunction of the one or more high level applications. Further, the trained machine learning model may be further trained to determine one or more low level applications that are configured similarly to one or more high level applications. For example, the trained machine learning model may be configured and/or trained to determine the similarity of a low level application to a high level application based on similar dependencies. The trained machine learning model may then be configured to determine that the one or more low level applications are included in the plurality of application failover waves that are executed before the plurality of application failover waves that include the one or more high level applications.

Further, the trained machine learning model may be updated over time with additional training data. The trained machine learning model may receive new data and iterate through the process previously described in steps 310-345. The new data may comprise additional sets of applications, application failover waves, technical recovery exercises, services, data, and/or other information that may be used to generate output data associated with the one or more criteria. The training data may be based on event data and/or output data as described herein.

The output data generated in step 345 may be validated against ground truth output that indicates which of the one or more applications have successfully completed a failover and which of the applications have not successfully completed a failover. The technical recovery exercise model may then use the validations to improve the performance of the trained machine learning model by iteratively cycling (e.g., iteratively cycle in a forward and reverse direction) through the steps of execution of applications, generation of event data, use of event data (e.g., generation of output data based on event data provided as input to the trained machine learning model, use of output data (e.g., receiving output from the trained machine learning model, and/or validation of the output data (e.g., determining whether the output data satisfies one or more criteria) until the trained machine learning model is configured and/or trained to more accurately determine whether the one or more criteria have been satisfied.

FIG. 4 illustrates an example flow chart for a method of training a machine learning model according to aspects of the disclosure. The steps of the method 400 are described with respect to FIG. 4 and may be implemented by a suitable computing system, as described further herein. For example, steps of the method described with respect to FIG. 4 may be implemented by any suitable computing environment by a computing device and/or combination of computing devices, such as computing devices 101, 105, 107, and 109 of FIG. 1. Further, steps of the method described with respect to FIG. 4 may be implemented in suitable program instructions, such as in machine learning model 127, and may operate on a suitable training set, such as training data 129. One or more steps of the method described with respect to FIG. 4 may be performed as part of the method described with respect to FIG. 3. For example, steps 410 and/or 420 may be performed after performing step 345 which is described with respect to FIG. 3. Steps of the method described with respect to FIG. 5 may be modified, rearranged, omitted, and/or expanded without deviating from the scope of the present disclosure.

In step 410, the computing system may receive user feedback. The user feedback may indicate an efficacy associated with the determination that the output data satisfies the one or more criteria. For example, the request for user feedback may comprise requesting feedback indicating whether the trained machine learning model successfully predicted whether one or more applications of an application failover wave would successfully failover. By way of further example, the request for user feedback may comprise requesting feedback indicating whether a recovery point objective was achieved. The user may then provide feedback indicating whether or not the recovery point objective was achieved. Further, a user may indicate an extent to which an RPO was achieved (e.g., an additional amount of data that may be lost before meeting the threshold amount of data) or an extent to which an RPO was not achieved (e.g., an amount of data that was lost in addition to the threshold amount of data). By way of further example, the request for user feedback may comprise requesting feedback indicating whether a recovery time objective was achieved. The user may then provide feedback indicating whether or not the recovery time objective was achieved. Further, a user may indicate an extent to which an RTO was achieved (e.g., an additional amount of time that may be expended before meeting the threshold amount of time) or an extent to which an RPO was not achieved (e.g., an amount of time expended in addition to the threshold amount of time that was exceeded).

In step 420, the computing system may further train the trained machine learning model (e.g., the trained machine learning model generated in step 310 which was described with respect to FIG. 3). Training the trained machine learning model may be based on the user feedback. For example, if the user feedback indicates that one or more applications of an application failover wave were inaccurately predicted to successfully complete a failover, the computing system may further train the trained machine learning model such that the trained machine learning model is less likely to predict a successful completion of a failover in failover waves with similar event data. If the user feedback indicates that one or more applications of an application failover wave were accurately predicted to successfully complete a failover, the computing system may further train the trained machine learning model such that the trained machine learning model is more likely to predict a successful completion of a failover in failover waves with similar event data.

FIG. 5 illustrates an example flow chart for a method of training a machine learning model to determine whether output data satisfies one or more criteria according to aspects of the disclosure. The steps of the method 500 are described with respect to FIG. 5 and may be implemented by a suitable computing system, as described further herein. For example, steps of the method described with respect to FIG. 5 may be implemented by any suitable computing environment by a computing device and/or combination of computing devices, such as computing devices 101, 105, 107, and 109 of FIG. 1. Further, steps of the method described with respect to FIG. 5 may be implemented in suitable program instructions, such as in machine learning model 127, and may operate on a suitable training set, such as training data 129. One or more steps of the method described with respect to FIG. 5 may be performed as part of the method described with respect to FIG. 3. For example, steps 510, 520, 530, 540, and/or 550 may be performed as part of step 340. Further, each of the operations and/or determinations described in steps 510, 520, 530, 540, and/or 550 may be used as a sub-step in the determination of whether output data satisfies one or more criteria as described in step 340 with respect to FIG. 3. One or more steps of the method 500 may be used in the determination of whether output data satisfies one or more criteria that is described in step 340 with respect to FIG. 3. One or more of the steps of the method 500 may be performed in the order described herein or may be performed in a different order with one or more steps or portions of the steps being omitted. Further, one or more steps of the method 500 may be modified, rearranged, omitted, and/or expanded without deviating from the scope of the present disclosure.

In step 510, a computing system may determine that the output data (e.g., the output data that was generated in step 330 which was described with respect to FIG. 3) satisfying the one or more criteria may comprise the computing system determining that a system health score exceeds a threshold system health score. The system health score may be positively correlated with the one or more applications associated with the first application failover wave operating within one or more target key performance indicator (KPI) ranges. For example, the output data may comprise a system health score based on a combination of KPI indicators including application uptime, application downtime, an amount of time an application takes to process a transaction, network throughput, application error rates, application login approval rates, application login denial rates, and/or application resource usage (e.g., memory usage, network bandwidth usage, and/or processor usage). The computing system may compare KPI data from the output data to one or more target KPI ranges. Based on the KPI data indicating that performance is within the one or more target KPI ranges, the computing system may determine that the one or more criteria have been satisfied. Based on the KPI data indicating that performance is not within the one or more target KPI ranges, the computing system may determine that the one or more criteria have not been satisfied. In some embodiments, a weighting may be associated with each of the one or more KPI indicators such that some KPI indicators may make a greater contribution to the system health score than other KPI indicators. For example, application downtime may be weighted more heavily than network throughput.

In step 520, a computing system may determine that the output data satisfying the one or more criteria may comprise the computing system determining that a rate of logins to the one or more applications is less than a threshold rate of logins. A rate of logins that is less than the threshold rate of logins may be associated with abnormal operation of the one or more operations. For example, the output data may comprise a rate of logins (e.g., logins per minute, logins per hour, and/or logins per day). The computing system may compare the rate of logins from the output data to a threshold rate of logins. Based on the rate of logins exceeding the threshold rate of logins, the computing system may determine that the one or more criteria have been satisfied. Based on the rate of logins not exceeding the threshold rate of logins, the computing system may determine that the one or more criteria have not been satisfied.

In step 530, a computing system may determine that the output data satisfying the one or more criteria may comprise the computing system determining that an amount of data lost by the one or more applications associated with the first application failover wave not exceeding a threshold amount of data based on the RPO. The one or more criteria may comprise a recovery point objective (RPO). The threshold amount of data may comprise an average amount of data lost by the one or more applications, a total amount of data lost by the one or more applications, and/or a proportion of data lost (e.g., an amount of data lost relative to a total amount of data sent and/or received). For example, the computing system may compare the amount of data lost to a threshold amount of data. Based on the amount of data lost not being greater than or equal to the threshold amount of data, the computing system may determine that the one or more criteria are satisfied. Based on the amount of data lost being greater than or equal to the threshold amount of data, the computing system may determine that the one or more criteria are not satisfied.

In step 540, a computing system may determine that the output data satisfying the one or more criteria may comprise the computing system determining that an amount of time used to perform a failover of the one or more applications associated with the first application failover wave does not exceed a threshold amount of time based on the RTO. For example, the computing system may compare the amount of time used to perform a failover of the one or more applications associated with the first application failover wave to a threshold amount of time. Based on the amount of time not exceeding the threshold amount of time, the computing system may determine that the one or more criteria are satisfied. Based on the amount of time exceeding or being equal to the threshold amount of time, the computing system may determine that the one or more criteria are not satisfied.

In step 550, a computing system may determine that the output data satisfying the one or more criteria may comprise the computing system determining that a risk (e.g., the risk generated and/or used as part of the output described in step 335 with respect to FIG. 3) does not exceed a threshold risk. The output data may comprise a risk associated with executing one or more subsequent applications associated with a subsequent application failover wave (e.g., the one or more second applications associated with the second application failover wave). Further, the risk may be positively correlated with a probability that the one or more second applications lose data or do not complete a failover. For example, the computing system may generate and/or use a risk score associated with the probability that one or more second applications lose a threshold amount of data. If the risk score is less than a risk threshold, the computing system may determine that the one or more criteria were satisfied and one or more subsequent applications of a subsequent application failover wave may be executed. If the risk score exceeds a risk threshold, the computing system may determine that the one or more criteria were not satisfied and one or more subsequent applications of a subsequent application failover wave may not be executed.

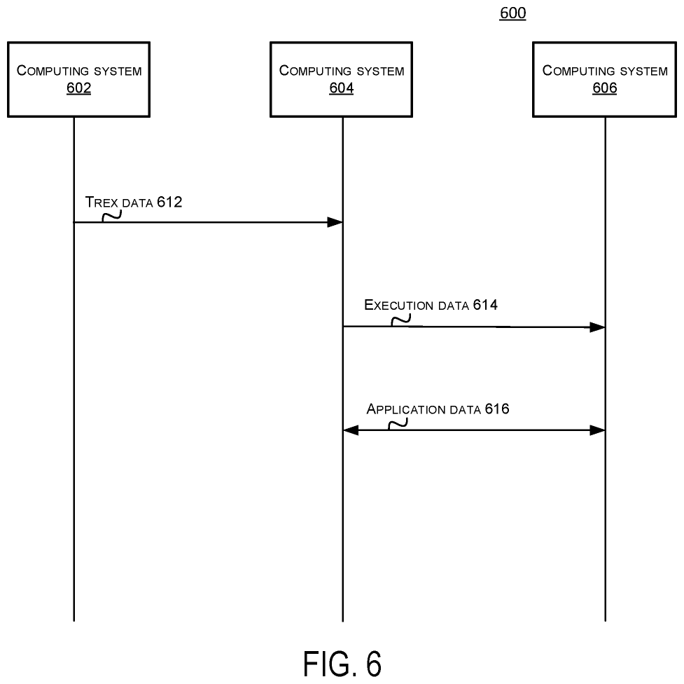

FIG. 6 illustrates a data flow associated with performance of technical recovery exercises according to aspects of the disclosure. Operations of the data flow 600 are described with respect to FIG. 6 and may be implemented by any suitable computing environment by a computing device and/or combination of computing devices, such as computing devices 101, 105, 107, and 109 of FIG. 1.

The computing system 602 (e.g., a computing system that stores and/or processes technical recovery exercise data) may send technical recovery exercise (TREx) data 612 to computing system 504. The technical recovery exercise data may comprise information associated with one or more applications associated with an application failover wave to the computing system 604. The computing system 602 may be similar to other computing systems described herein (e.g., the computing system 100 described with respect to FIG. 1).

The computing system 604 may be configured to receive the technical recovery exercise data. The computing system 604 may use the technical recovery exercise data to perform technical recovery exercises. The technical recovery exercises may comprise information associated with executing one or more applications of an application failover wave and generating event data based on monitoring the one or more applications. The computing system 604 may comprise a trained machine learning model (e.g., a machine learning model similar to the machine learning model 127) that is configured and/or trained to receive the event data and generate output data that may comprise a system health score associated with the health of the one or more applications of the application failover wave with respect to one or more criteria that may be used to determine whether to execute one or more subsequent applications of a subsequent application failover wave.

The computing system 604 may send execution data 614 to computing system 606. The execution data 614 may be used to initiate the execution of the one or more applications of the failover wave on the computing system 606. The computing system 604 may monitor computing system 606 as the one or more applications of the application failover wave are executed. Monitoring of the computing system 606 by the computing system 604 may comprise monitoring and/or analysis of application data 616 (e.g., data associated with execution of the one or more applications which may include event data and/or output data) which may be generated and/or used as a result of the execution of the one or more applications of the application failover wave. The computing system 604 may generate event data based on the monitoring of the computing system 606.

The computing system 604 may input event data into a machine learning model that is configured to generate and/or use output data. Based on the output data satisfying one or more criteria associated with determining whether an application failover wave has successfully failed over the computing system 604 may execute one or more subsequent applications associated with a subsequent application failover wave.

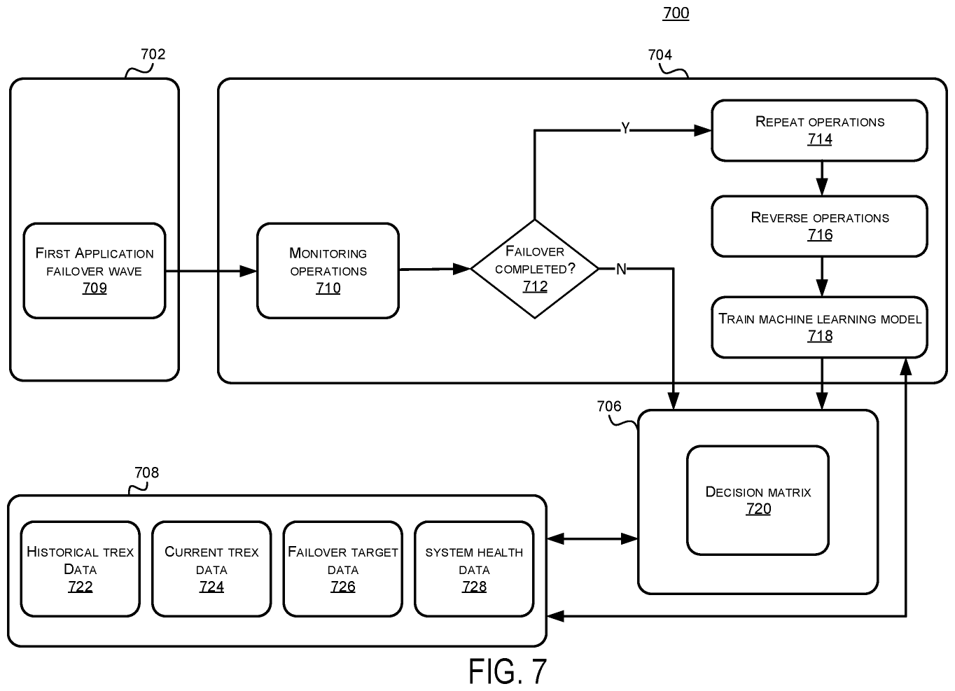

FIG. 7 illustrates an example of a system for performing and evaluating technical recovery exercises according to aspects of the disclosure. The operations of the system 700 described with respect to FIG. 7 may be implemented by any suitable computing environment by a computing device and/or combination of computing devices, such as computing devices 101, 105, 107, and 109 of FIG. 1.

The computing system 702 may be used to perform one or more technical recovery exercises using one or more applications that are executed on the computing system 702. The one or more technical recovery exercises may be performed in one or more application failover waves comprising one or more applications that may be executed until some criteria have been met (e.g., an application failover is successfully completed, an application failover is not successfully completed, an RPO threshold is met, and/or an RTO threshold is met).

The one or more technical recovery exercises performed on the computing system 702 may be performed on a first application failover wave 709. Further, the computing system 702 may perform monitoring operations 710 in which one or more events of the first application failover wave 709 are detected and/or analyzed. The computing system 704 may use the monitoring operations 710 to generate event data that may be provided as an input to a trained machine learning model (e.g., a machine learning model that is similar to the machine learning model 127 that is described with respect to FIG. 1) that is configured to generate output data that may comprise a prediction of whether a failover of the first application failover wave has been completed. The operations 712 may be based on the output data generated by the trained machine learning model and may be used to determine whether the first application failover wave 708 has been successfully completed. Based on the output data indicating that the first application failover wave 708 has been successfully completed, the operations 714 (e.g., operations comprising repeating operations 10) may be performed. Based on the output data indicating that the first application failover wave 708 has not been successfully completed, data indicating that the first application failover wave 708 has not been successfully completed may be sent to computing system 706.

The operations 714 may be performed on a subsequent application failover wave (e.g., a second application failover wave) that may comprise one or more applications that are executed on the computing system 702. Further, the operations 714 may comprise monitoring an application failover wave, generating event data based on monitoring the application failover wave, and inputting the event data into a trained machine learning model (e.g., the trained machine learning model described with respect to the operations 712) to generate output data comprising a prediction of whether the application failover wave has been successfully completed. The operations 716 may be performed after the operations 714 and may comprise repeating the operations 714 in a different order (e.g., in a reverse order) so that the event data based on monitoring a subsequent application failover wave (e.g., a second application failover wave) may be further analyzed. Performing the operations 716 may comprise the computing system 704 analyzing the event data and generating and/or using RPO data, RTO data, KPI data, and/or incident data to perform operations 718 to further train the trained machine learning model.

After performing the operations 718, data associated with the RPO data, RTO data, KPI data, and/or incident data from the operations 716 may be sent to the computing system 706 and used to update the decision matrix 720. Updating the decision matrix 720 may comprise updating one or more rules associated with the RPO data, RTO data, KPI data, and/or incident data from the operations 716. The decision matrix 720 may comprise one or more rules that may be used to determine whether a failover of an application failover wave has been successfully completed and/or whether one or more applications of a subsequent application failover wave may be executed. For example, the decision matrix 720 may comprise one or more rules based on one or more RPO thresholds, one or more RTO thresholds, and/or various KPI ranges that may be used in the determination of whether a failover of an application failover wave has been successfully completed and/or whether one or more applications of a subsequent application failover wave may be executed. In this example, the decision matrix 720 may be stored in the computing system 706, in other embodiments, the decision matrix 720 may be stored on one or more other computing systems (e.g., the computing system 702, the computing system 704, and/or the computing system 708).

If the operations 712 determined that a failover of an application failover wave has not been successfully completed, the decision matrix 720 may be used to determine whether to execute one or more applications of a subsequent application failover wave. For example, application of the one or more rules of the decision matrix 720 to the event data and/or output data may result in a determination that one or more RPO thresholds, one or more RTO thresholds, and/or one or more KPIs have been met and that one or more applications of a subsequent application failover wave may be executed.

The computing system 708 may send data to and/or receive data from the computing system 704 and/or the computing system 706. The data received by the computing system 708 may comprise event data, output data, RPO data, RTO data, KPI data, and/or incident data. The computing system 708 may comprise historical technical recovery exercise (TREx) data 722, current TREx data 724, failover target data 726, and/or system health data 728. The historical TREx data 722 may comprise data from previously performed technical recovery exercises including historical failover times, historical RPOs, historical RTOs, and/or historical incidents. The current TREx data 724 may comprise data from a current or recently performed technical recovery exercises including one or more failover times, historical RPOs, historical RTOs, and/or historical incidents. The failover target data 726 may comprise RPO thresholds, RTO thresholds, and/or failover time targets. The system health data 728 may comprise information associated with the state of one or more computing systems (e.g., the computing system 702) that the technical recovery exercises may be performed on. The data stored on the computing system 708 (e.g., the TREx data 722, current TREx data 724, failover target data 726, and/or system health data 728) may be communicated with the computing system 704 and/or the computing system 706. Further, the data stored on the computing system 708 may be used to further train the trained machine learning model and/or update the decision matrix 720.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The steps of the methods described herein are described as being performed in a particular order for the purposes of discussion. A person having ordinary skill in the art will understand that the steps of any methods discussed herein may be performed in any order and that any of the steps may be omitted, combined, and/or expanded without deviating from the scope of the present disclosure. Furthermore, the methods described herein may be performed and/or implemented using any manner of device, system, apparatus, and/or non-transitory computer readable media including the computing devices, computing systems, computing apparatuses, and/or non-transitory computer readable media that are described herein.

What is claimed is:

1. A computer-implemented method comprising:
training a machine learning model using training data indicating historical technical recovery exercises and downtimes associated with the historical technical recovery exercises, wherein the machine learning model is implemented using an artificial neural network, and wherein the training the machine learning model comprises weighting one or more nodes of the artificial neural network based on the training data;
receiving, by a computing device, technical recovery exercise data that indicates, for each of a plurality of application failover waves, one or more different technical recovery exercises;
for a first application failover wave of the plurality of application failover waves:
executing, by the computing device, one or more applications associated with the first application failover wave;
generating, by the computing device and by monitoring one or more events associated with the one or more applications associated with the first application failover wave during one or more first technical recovery exercises of the first application failover wave, event data;
providing, as input to the trained machine learning model, the event data; and
receiving, as output from the trained machine learning model, output data, based on the event data, associated with application downtime; and
based on determining that the output data satisfies one or more criteria, executing one or more second applications associated with a second application failover wave of the plurality of application failover waves.

2. The method of claim 1, wherein the output data comprises a system health score, wherein the system health score is positively correlated with the one or more applications associated with the first application failover wave operating within one or more target key performance indicator (KPI) ranges, and wherein the determining that the output data satisfies the one or more criteria comprises determining that the system health score exceeds a threshold system health score.

3. The method of claim 1, wherein the one or more criteria comprise a threshold rate of logins to the one or more applications associated with the first application failover wave, and wherein the determining that the output data satisfies the one or more criteria comprises determining that a rate of logins to the one or more applications is less than the threshold rate of logins.

4. The method of claim 1, further comprising:
determining, based on the output data, an order of performing the plurality of application failover waves that is associated with satisfying the one or more criteria.

5. The method of claim 1, further comprising:
receiving user feedback indicating an efficacy associated with the determining that the output data satisfies the one or more criteria; and
further training, based on the user feedback, the trained machine learning model.

6. The method of claim 1, wherein the one or more second applications associated with the second application failover wave are different from the one or more applications associated with the first application failover wave.

7. The method of claim 1, wherein the one or more different technical recovery exercises comprise one or more of:
a chaos experiment,
regional isolation of the one or more applications, and
automated traffic switching of the one or more applications.

8. The method of claim 1, wherein the one or more criteria comprise a recovery point objective (RPO), and wherein the determining that the output data satisfies the one or more criteria comprises determining that an amount of data lost by the one or more applications associated with the first application failover wave does not exceed a threshold amount of data based on the RPO.

9. The method of claim 1, wherein the one or more criteria comprise a recovery time objective (RTO), and wherein the determining that the output data satisfies the one or more criteria comprises determining that an amount of time used to perform a failover of the one or more applications associated with the first application failover wave does not exceed a threshold amount of time based on the RTO.

10. The method of claim 1, wherein the output data comprises a risk associated with executing the one or more second applications associated with the second application failover wave, wherein the determining that the output data satisfies the one or more criteria comprises determining that the risk does not exceed a threshold risk, and wherein the risk is positively correlated with a probability that the one or more second applications lose data or do not complete a failover.

11. The method of claim 1, wherein the output data comprises a number of the one or more second applications associated with the second application failover wave.

12. The method of claim 1, wherein the output data comprises one or more indications of one or more types of the one or more second applications associated with the second application failover wave.

13. A computing device, comprising:
one or more processors; and
memory storing instructions that, when executed by the one or more processors, cause the computing device to perform steps comprising:
training a machine learning model using training data indicating historical technical recovery exercises, key performance indicator (KPI) ranges, and downtimes associated with the historical technical recovery exercises, wherein the machine learning model is implemented using an artificial neural network, and wherein the training the machine learning model comprises weighting one or more nodes of the artificial neural network based on the training data;
receiving technical recovery exercise data that indicates, for each of a plurality of application failover waves, one or more different technical recovery exercises;
for a first application failover wave of the plurality of application failover waves:
executing one or more applications associated with the first application failover wave;
generating, by monitoring one or more events associated with the one or more applications associated with the first application failover wave during one or more first technical recovery exercises of the first application failover wave, event data;
providing, as input to the trained machine learning model, the event data; and
receiving, as output from the trained machine learning model, output data, based on the event data, associated with application downtime; and
based on determining that the output data satisfies one or more criteria, executing one or more second applications associated with a second application failover wave of the plurality of application failover waves.

14. The computing device of claim 13, wherein the one or more criteria comprise a recovery point objective (RPO), and wherein the determining that the output data satisfies the one or more criteria comprises determining that an amount of data lost by the one or more applications associated with the first application failover wave does not exceed a threshold amount of data based on the RPO.

15. The computing device of claim 13, wherein the one or more criteria comprise a recovery time objective (RTO), and wherein the determining that the output data satisfies the one or more criteria comprises determining that an amount of time used to perform a failover of the one or more applications associated with the first application failover wave does not exceed a threshold amount of time based on the RTO.

16. The computing device of claim 13, wherein the output data comprises a risk associated with executing the one or more second applications associated with the second application failover wave, wherein the determining that the output data satisfies the one or more criteria comprises determining that the risk does not exceed a threshold risk, and wherein the risk is positively correlated with a probability that the one or more second applications lose data or do not complete a failover.

17. A non-transitory machine-readable medium storing instructions that, when executed by one or more processors, cause the one or more processors to perform steps comprising:
training a machine learning model using training data indicating historical technical recovery exercises and downtimes associated with the historical technical recovery exercises, wherein the machine learning model is implemented using an artificial neural network, and wherein the training the machine learning model comprises weighting one or more nodes of the artificial neural network based on the training data;
receiving technical recovery exercise data that indicates, for each of a plurality of application failover waves, one or more different technical recovery exercises;
for a first application failover wave of the plurality of application failover waves:
executing one or more applications associated with the first application failover wave;
generating, by monitoring one or more events associated with the one or more applications associated with the first application failover wave during one or more first technical recovery exercises of the first application failover wave, event data;
providing, as input to the trained machine learning model, the event data; and
receiving, as output from the trained machine learning model, output data, based on the event data, associated with application downtime, wherein the output data comprises a system health score that is positively correlated with the one or more applications operating within one or more target key performance indicator (KPI) ranges; and
based on determining that the output data satisfies one or more criteria, executing one or more second applications associated with a second application failover wave of the plurality of application failover waves, wherein the determining that the output data satisfies the one or more criteria comprises determining that the system health score exceeding a threshold system health score.

18. The non-transitory machine-readable medium of claim 17, wherein the one or more criteria comprise a recovery point objective (RPO), and wherein the determining that the output data satisfies the one or more criteria comprises determining that an amount of data lost by the one or more applications associated with the first application failover wave does not exceed a threshold amount of data based on the RPO.

19. The non-transitory machine-readable medium of claim 17, wherein the one or more criteria comprise a recovery time objective (RTO), and wherein the determining that the output data satisfies the one or more criteria comprises determining that an amount of time used to perform a failover of the one or more applications associated with the first application failover wave does not exceed a threshold amount of time based on the RTO.

20. The non-transitory machine-readable medium of claim 17, wherein the one or more second applications associated with the second application failover wave are different from the one or more applications associated with the first application failover wave.
